(19) United States
(12) Patent Application Publication
(10) Pub. No.: US 2012/0151311 A1
(43) Pub. Date: Jun. 14, 2012

(54) SYSTEM AND METHOD FOR GENERATING A CUSTOMIZED TASK LIST

(75) Inventors: Jackson Mathai, Heidelberg (DE); Sabine Finke, Karlsruhe (DE)

(73) Assignee: SAP AG, Walldorf (DE)

(21) Appl. No.: 12/963,240

(22) Filed: Dec. 8, 2010

(51) Int. Cl. G06F 3/14; G06F 17/20

(52) U.S. Cl. 715/205; 715/243

(57) ABSTRACT

Disclosed embodiments provide a system, machine-readable medium and a method that may generate user-defined task management device. A system for navigating through a number of different computer applications to complete a task. In a graphical user interface generated by a processor, a screenflow template is presented to a user via a list of screens, tasks and applications outlining steps in a process. Based on user inputs, a user-defined screenflow may be generated that incorporates screens for data entry and informational purposes, intermediate tasks for completion of the process, and computer applications for processing inputted and retrieved data. A screen of the user-defined screenflow may access data storage to obtain data required to complete the task.

### BACKGROUND

The disclosed subject matter relates to a system and method for generating a customized task list. In particular, the present application is directed to consolidating and minimizing multiple navigation steps to complete a process involving a number of different computer applications, such as an enterprise resources planning application or a customer relationship management application.

Certain computerized tasks involve multiple steps that require accessing different computer applications, or collection and analysis of data from multiple sources. The repetitive navigation from one screen to another screen of a different computer application causes delays in completing the computerized task. For example, in a human resources task such as processing information for a new employee, a user system may be required to define personal data for the new employee as well define the compensation, payroll information, time management data, and the like. Each of the tasks requires different windows of content and different user interfaces (UIs) to complete the processing of the new employee information. The different controller and UIs may be different screens, tasks, applications, third party applications, documents (Excel™, Word™ and the like).

In processes that require a large number of steps and navigation between multiple systems, the navigation between the different windows of content and access time for multiple applications may be time consuming and complex. Attempts to ease the complexity and time consumption have been made by introducing a guided activity in which a user is guided through a series of steps. For example, a guided activity may be a predefined configuration of a sequence of screens developed at design time for accomplishing an activity that generally can be completed in a relatively brief amount of time, such as less than one hour. Presently, the guided activities may not be customized by a user. Additionally, tasks that require approvals by other users or that depend on the availability of additional information that the user does not control may take longer than one hour. In those cases, guided activities are not useful as the user session may be closed out and the guided task may not restart at a later time from the point where the user stopped using the guided activity. Additionally, guided activities are not enabled to cover a whole business process, such as a recruitment process with compensation, payroll, time management and the like. Guided Activities always only cover parts of this process such as the creation of compensation data.

Accordingly, the inventors have recognized the need for a process and tool to allow more efficient and customized navigating through the multiple windows of the different computer applications to accomplish complex tasks. The tool also may be configured at run time and may be updated and shared among a plurality of users.

### BRIEF DESCRIPTION OF THE DRAWINGS

FIG. 1 illustrates a graphic for implementing a task template generator according to an embodiment of the present invention.

FIG. 2 illustrates exemplary user interaction with the task template generator according to an embodiment of the present invention.

FIG. 3 illustrates an exemplary user-defined screenflow for completing an exemplary task according to an embodiment of the present invention.

FIG. 4 illustrates yet another exemplary user-defined screenflow for completing an exemplary task according to an embodiment of the present invention.

FIG. 5 illustrates an exemplary process for generating a user-defined screenflow for completing an exemplary task according to an embodiment of the present invention.

FIG. 6 illustrates an exemplary scenario for sharing the tasks for collaboration with others according to an embodiment of the present invention.

FIG. 7 illustrates another exemplary user interaction with the task template generator according to an embodiment of the present invention.

FIG. 8 illustrates an exemplary system for generating a user-defined screenflow for completing an exemplary task according to an embodiment of the present invention.

### DETAILED DESCRIPTION

Described embodiments may provide for a run-time generated, user-defined task management device. In response to an output from a graphical user interface at run-time, a screenflow template may be accessed by a processor for completing a task. The screenflow template may have a plurality of data fields. The processor may identify screens usable for completing a task associated with the accessed screenflow template based on data input into a data field of the plurality of data fields. The screenflow template may be presented in a first portion of a screen of a graphical user interface, and the identified screens in a second portion of the screen of the graphical user interface to generate a task screenflow. The processor, in response to a selection of a screen, may populate in the first portion of the screen data fields in the plurality of data fields in the screenflow template with the selected screen. In the graphical user interface, a run-time, user-defined task screenflow for completing the task may be presented.

Disclosed embodiments also present a system for navigating through a number of different computer applications to complete a task. In a graphical user interface generated by a processor, a screenflow template is presented to a user via a list of screens, tasks and applications outlining steps in a process. Based on user inputs, a user-defined screenflow may be generated that incorporates screens for data entry and informational purposes, intermediate tasks for completion of the process, and computer applications for processing inputted and retrieved data. A screen of the user-defined screenflow may access data storage to obtain data required to complete the task.

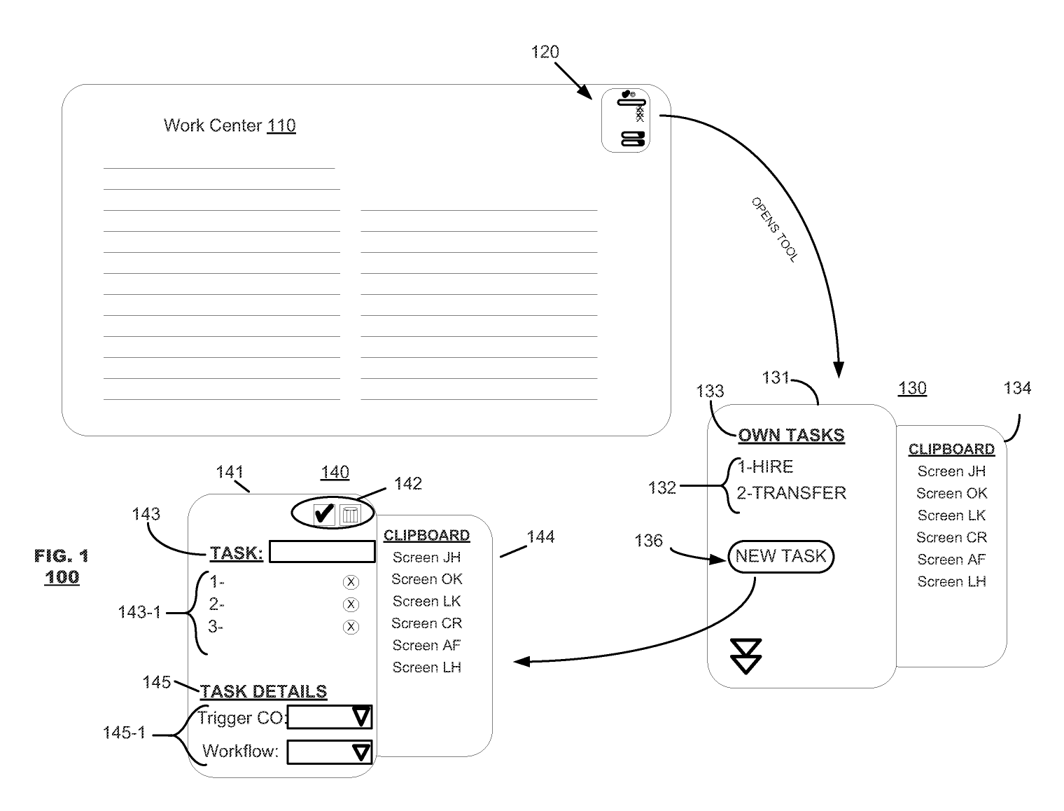

FIG. 1 illustrates a graphic of a process for implementing the template generator according to an embodiment of the present invention. In the process 100, a user may be presented with a work area 110 that may contain content, such as human resources information, invoicing information, and the like. An icon 120 in the work area 110 may be selected by a user. Selection of the icon 120 may cause a screenflow template tool 130 to be opened by a graphical user interface, and cause the screenflow template tool 130 to be presented on a display to a user. The screenflow template tool 130 may present to a user a screenflows task menu 131. The screenflows task menu 131 may include the user's “own tasks” under the heading 133 (the user “owns” (i.e., is responsible for) these tasks), and a screenflow list 132 of a user's existing screenflow tasks, for example, 1-hire and 2-transfer tasks. The screenflows task menu 131 may also provide a control 136 for a user to select to create a new task. In addition, a clipboard 134 of screens that may be used to build a screenflow task may be presented, for example, adjacent to the screenflows task menu 131. Each of the screens in the clipboard 134 may represent the most commonly used screens to accomplish most tasks or by a user, or be a personalized list of screens specific to a particular user. Upon selection of the new task 136 control, the graphical user interface may generate a screenflows task generator 140. The screenflows task generator 140 may include a number of different portions of the graphical user interface that presents different display and interaction areas, such as screenflow task template 141 and the clipboard 144. The screenflow task template 141 provides saving and discarding icons 142, a task naming input field 143, data fields 143-1 for entering screens from, for example, the clipboard 144, a tasks detail 145 header indicating data fields 145-1, such as, for example, trigger computer object (CO) and workflow. The data fields 145-1 may have pull down menus for further selection of triggering computer objects and workflow descriptions.

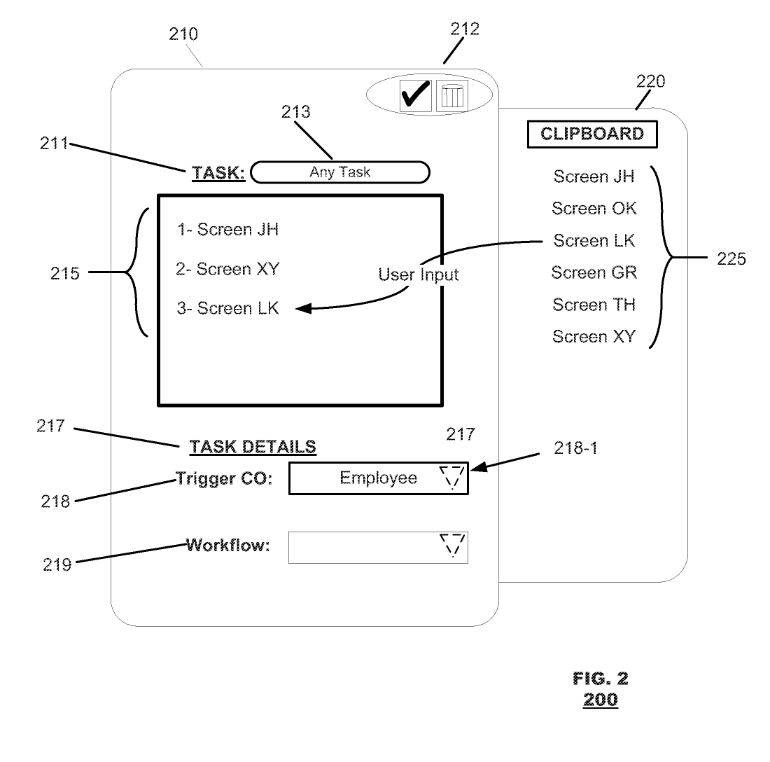

Upon presentation of the screenflow task template 141 by the graphical user interface, a user may begin interacting with the generator 140 to create a task screenflow. The user will be considered the owner of the created task screenflow. FIG. 2 illustrates exemplary user interaction with a template generator according to an embodiment of the present invention. The screenflows task generator 200 may include a screenflow task template 210 and clipboard 220. The screenflow task template 210 may include task naming input field 211, screens list 215 and task detail header 217. The task naming input field 211 may include task name field 213. The screenflow task template 210 may be saved or deleted using the icons 212. Screenflow list 215 may list screens that have been added to the task as named in task name field 213, which in this case, the name of the task is “complete employee data.” The screens in screenflow list 215, such as Screen JH, Screen XY and Screen LK, may represent data entry screens in different computer applications, or in the same computer applications, (i.e., “complete employee data”). For example, screen JH may be a screen for entering personal data such as birth date, emergency contact number, and similar information, for human resources information, while screen XY may be a screen for entering information related to taxation, such as the number of dependent children of the employee, and marital status.

The details of the particular task may be input in the data fields under the task detail header 217. Data fields 218 and 219 may be populated with data indicating a computer object (Trigger CO) that triggers screens for the screenflow list 215, and the workflow 219. The task trigger CO field 218 may be populated with a name of a computer object. In an alternative embodiment, the menu device 218-1 may be used to populate the task trigger CO field 218 with known computer objects. The workflow field 219 may indicate the order in which the screens of the screenflow list 215 are to be executed. In the illustrated example, the workflow field 219 is empty, so the execution order of the screens does not matter for the proper completion of the task.

As illustrated, the clipboard 220 may include a list of screens that are commonly used for tasks. The screens 225 listed in the clipboard 220 may be identified by a link name, similar to a uniform resource locator (URL) address. Alternatively, link names to data storage locations may also be used for a particular screen. In general, the screens 225 may each have a unique identifier as a link so that the task 211 can be completed by following the link for the screens 225 in the screenflow list 215. Screens 225 listed in the clipboard 220 may be selected with a user input and placed (i.e., drag and drop) in the screenflow list 215. Other input methods may also be used such as directly typing in the screen link name, or address into the screenflow list 215.

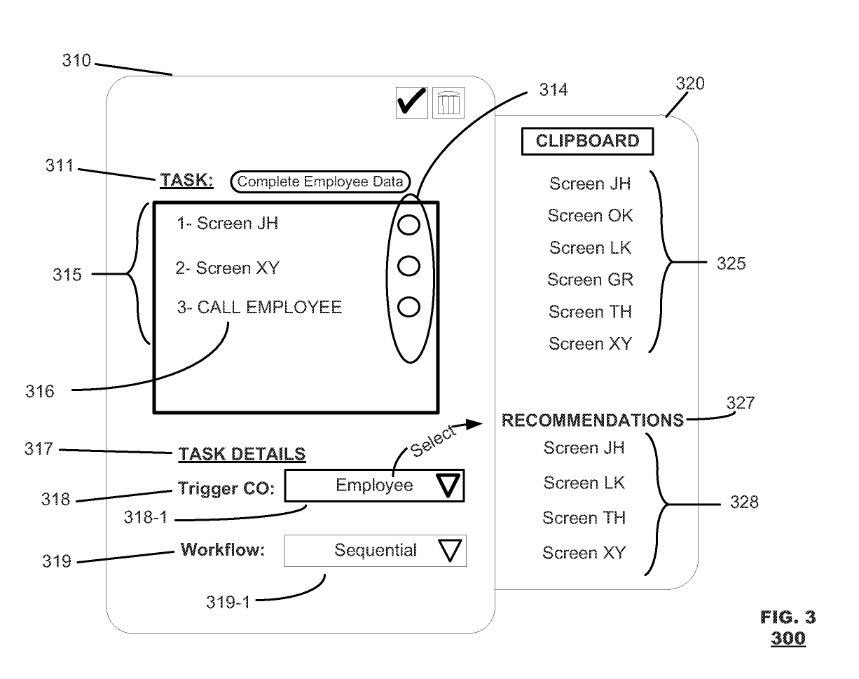

Another exemplary user-defined screenflow for completing an exemplary task according to an embodiment of the present invention may be illustrated in FIG. 3. Similar to that of FIG. 2, the task generator 300 may include a screenflow task template 310 and clipboard 320. The screenflow task template 310 may include a tasking naming input field 311, a screenflow list 315, and tasks details field 317. In the screenflow list 315, a screen 316 may be a user generated screen such as a task that may be input by the user. The screens in the screen list may not only be links to a file or an application, but may also be user-defined tasks such as “Call Employee.” Any number of user-defined screens 316 may be used in the screens list. In addition, screen status indicators 314 may provide a color-coded (e.g., green-yellow-red) indicator, or a graphical indicator (e.g., dashed line, an X, or the like), of the status of the screen to the user. The status indicators 314 provide the user with an indication of the progress of the task.

The task details field 317 may include the task trigger CO field 318 and the workflow field 319. The task trigger CO field 318 has a data field 318-1 for entry of a name of a computer object (CO) that reflects the type of computer object that will be operated on by the task. A computer object, for example, can be “Employee”, which means that all instances in the system of the object type “Employee” can trigger the specified task list. The data field 318-1 may have a menu device 318-2, for example, a drop-down menu control. The names presented in the data field 318-1 menu may be those that may be based on a user-role, or may be those most commonly used by users. An additional feature shown in FIG. 3 is that in response to the selection of a computer object for data field 318-1, the clipboard 320 may be updated in the recommendations section 327 with recommended screens 328 that are related to the selected computer object in data field 318-1. The recommended screens 328 may include a screen from the list of screens 325 of the clipboard 320. Similar to the task trigger CO field 318, the workflow field 319 may have a workflow indicator field 319-1 that also may include a menu device 319-2. The menu device 319-2 may present choices of workflow indicators for indicating whether the actions related to the screenflow list 315 and tasks 316 need to be completed in a set order (e.g., sequentially), or may be completed randomly.

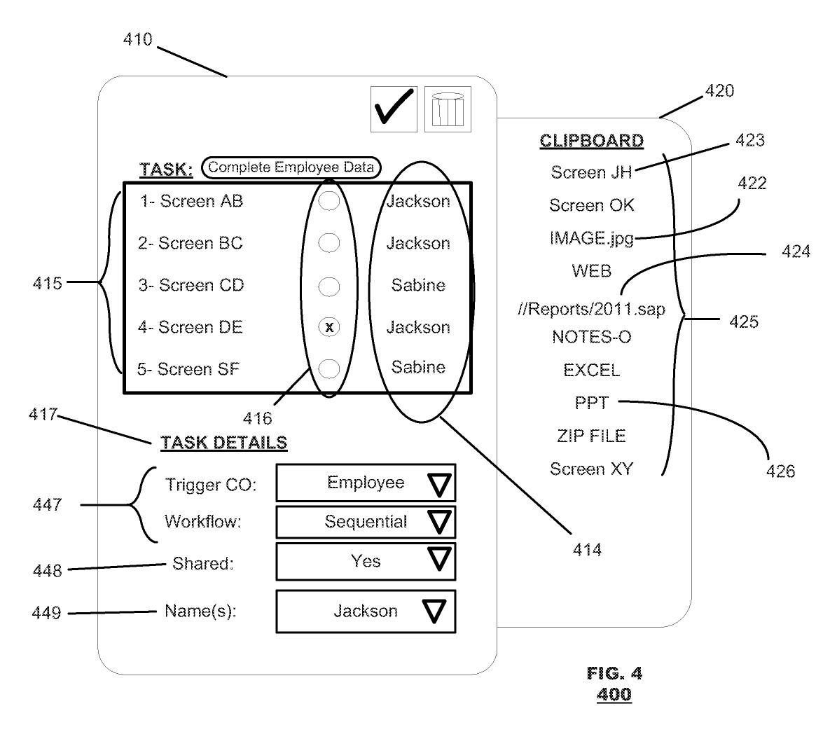

FIG. 4 illustrates yet another exemplary user-defined screenflow for completing an exemplary task according to an embodiment of the present invention. The generator 400 may include a screenflow task template 410 and clipboard 420. The screenflow task template 410 is similar to the previously described generator tables 210 and 310. Additional features in the screen list 41 of the screenflow task template 410 may include screen status indicators 416, and task responsibility fields 414. As illustrated the screen status indicator 416 for screen “4-screen DE” is shown as completed by the crossed out box, while the other screens have not yet been completed. Each of the screens (which represent a task) in the screenflow list 415 are shown as assigned to a responsible party. For example screen task “1-Screen AB” is assigned to “Jackson”, while screen task “3-Screen CD” is assigned to “Sabine.” Of course, a screen task does not have to be assigned to any one person.

The task details field 417 may include additional fields Shared 448 and Name(s) 449, in addition to fields 447, the task trigger CO field and the workflow field. The shared field 448 may indicate another user with whom the task in the task screen is shared, or merely indicate whether the “Complete Employee Data” task is shared with any other users. As result of the sharing, the other user(s) can also add steps to the task list which then can be seen by all other participants. Responsibilities can also be set between the participants of the task lists which is reflected by the names behind each task step. The names in the Name(s) 449 field are users with whom the task may be shared. The named user may receive a copy of the generated task table 410, and may update the task for themselves as well as share the task with other users.

An additional feature shown in FIG. 4 is the clipboard 420 may include in the listing of screens 425 not only screens, such as screen JH 423, but also files, such as image file 422 and document file 424, and computer applications 426, such as PowerPoint™, and the like. Therefore, a user may incorporate nearly any electronic documents, or functionality needed to complete a task into the generated task. In addition, as tasks, such as “complete employee data” evolve, so too may the task. For example, a photograph of an employee may be required for security purposes, and the ability to incorporate an image file containing the photograph may be necessary. Alternatively, a screen, such as screen JH may collect data that is repetitive to, for example, another computer application such as PPT 426. In which case, a user may delete screen JH from the list of screens 415. The generation of the task may be limited only by the number of different steps required to complete the task. A user may incorporate contacts, task requests and the like into the generated task as shown in task template 410.

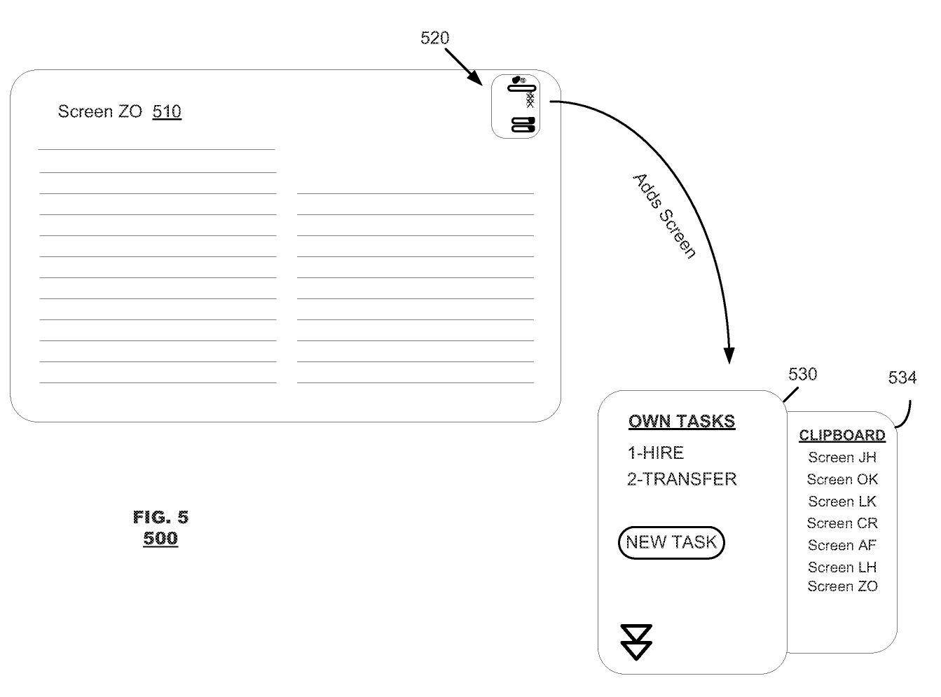

FIG. 5 illustrates an exemplary scenario for adding a screen to the task generator according to an embodiment of the present invention. In the scenario 500, a screen 510, such as Screen ZO, may be presented to a user. The screen ZO 510 may include an icon 520 that when selected may incorporate the screen into the clipboard 534 of the screenflow template tool 530.

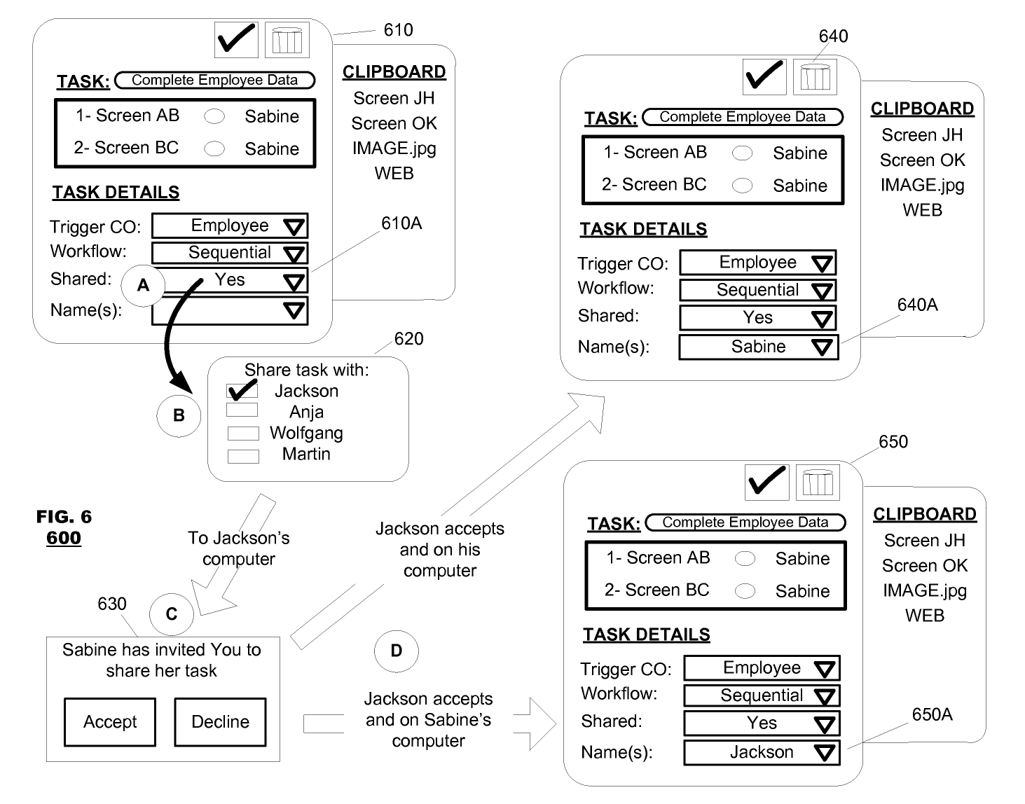

FIG. 6 illustrates an exemplary scenario for sharing the tasks for collaboration with others according to an embodiment of the present invention. In the sharing scenario 600, a user has an option of sharing a task by indicating “YES” (at A) in the shared field 610A of the task board 610. A share dialog box 620 may be presented to the user for selection of a person(s) with whom to share the task. At B, the user may choose “Jackson” as a user with whom the task will be shared. On Jackson's computer (or PDA, smartphone or similar device), a dialog box 630 may be presented offering Jackson to share the task. If Jackson chooses to ACCEPT in B, Jackson's computer may be presented with the task board 640. Note that in the Name(s) data field 640A, the name “Sabine”, the owner of the task, is added as the name with whom the task is shared. Similarly, on Sabine's computer (PDA or the like), the task board 650, which is substantially the same as task board 610, except the Name(s) field 650A is updated with the name “Jackson”, the name of the person with whom the task is shared. This is an example of the collaborative nature of the tasks. Jackson may similarly share the task with another user, but Sabine would not be made aware of Jackson's sharing of the task because Jackson may take over as the task owner for tasks that he shares with others besides Sabine.

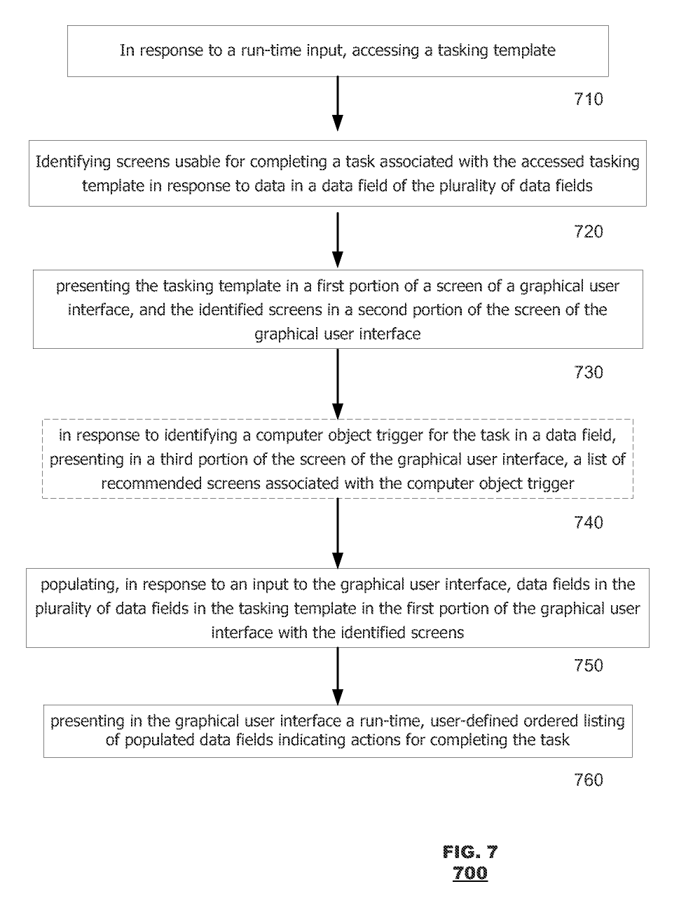

FIG. 7 illustrates an exemplary process for generating a task according to an embodiment of the present invention. The process 700 may begin, at step 710, where in response to a run-time input, a tasking template may be presented to a user. Computer objects, in step 720, may be identified in response to data in a data field of the plurality of data fields that are usable for completing a task associated with the associated with the accessed tasking template. The tasking template may be presented, in step 730, in a first portion of a screen of a graphical user interface, and the identified computer objects in a second portion of the screen of the graphical user interface. Optionally, in response to identifying a computer object trigger for the task in a data field at step 740, a list of recommended computer objects associated with the computer object trigger may be presented in a third portion of the screen of the graphical user interface. At step 750, in response to a selection input to the graphical user interface, the first portion of the screen data fields in the plurality of data fields in the screenflow template may be populated with the selected computer objects. In the graphical user interface, a run-time, user-defined ordered listing of data fields populated with selected computer objects for completing the task may be presented at step 760.

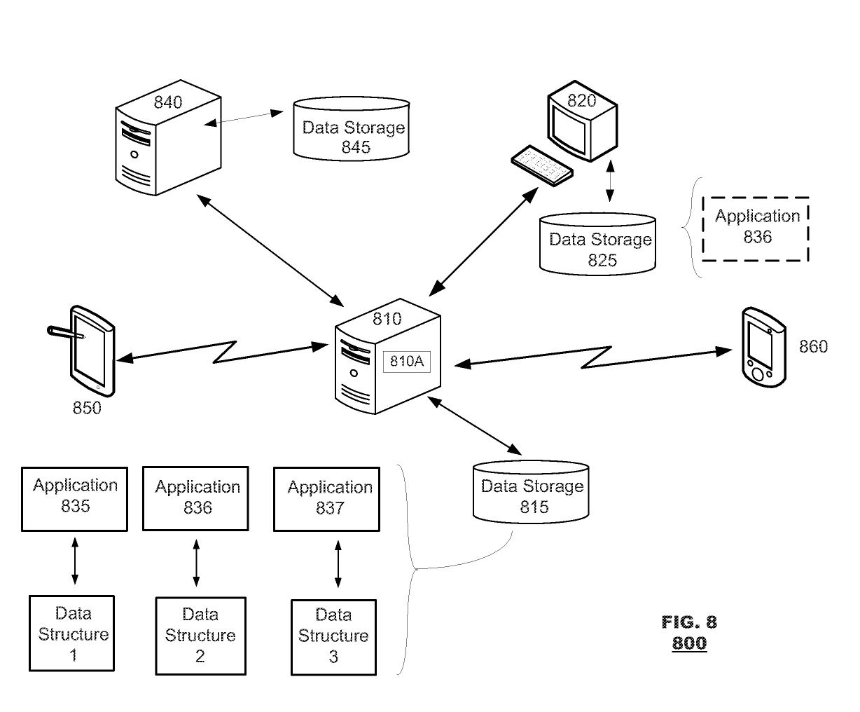

FIG. 8 illustrates an exemplary system for generating a user-defined screenflow for completing an exemplary task according to an embodiment of the present invention. The exemplary system 800 may include an enterprise server 810, a content server 840, client terminal 820, a tablet remote device 850, a PDA or smartphone 860, and data storage devices 815, 825 and 845. The enterprise server 810 may include a processor 810A that executes computer program instructions that may be accessed in the data storage 815. For example, computer applications 835, 836, and 837 may be stored in data storage 815, which the processor 810A may access based on inputs received from any of client terminal 820, tablet computer 850 and PDA/smartphone 860. The computer application 836 may, for example, have code that is executed by the processor 810A that provides the task generator discussed above. The generated task may be stored in a data structure such as data structure 2 in the data storage 815, or at data storage 825. The above described task generator may be presented on any of the client terminal 820, tablet computer 850 and PDA/smartphone 860. Similarly, other applications, for example, 835 and 837, and respective data structures, data structure 1 and data structure 3 may be accessed by any of the devices 820, 850 and 860 via the server 810. The content server 840 may serve content included in the screens in the screenflow list of the task generator. The content may be stored in data storage 845 for more rapid access, or the content server 840 may access a web server or other system, such as a customer relationship management system, for the requested content. Similarly, the data structures 1 and 3 may be accessed by the task generator via calls to the computer applications 835 and 837. Additionally, other devices such as client terminal 820, may execute the application 836 to provide the task generator.

The exemplary method and computer program instructions may be embodied on a machine readable storage medium such as a computer disc, optically-readable media, magnetic media, hard drives, RAID storage device, and flash memory. In addition, a server or a database server may include machine readable media configured to store machine executable program instructions. The features of the disclosed embodiments may be implemented in hardware, software, firmware, or a combination thereof and utilized in systems, subsystems, components or subcomponents thereof. When implemented in software, the elements of the disclosed embodiments are programs or the code segments used to perform the necessary tasks. The program or code segments can be stored on machine readable storage media. The “machine readable storage media” may include any medium that can store information. Examples of a machine readable storage medium include electronic circuits, semiconductor memory device, ROM, flash memory, erasable ROM (EROM), floppy diskette, CD-ROM, optical disk, hard disk, fiber optic medium, or any electromagnetic or optical storage device. The code segments may be downloaded via computer networks such as

Internet, Intranet, etc. The described system may be incorporated into the functionality of other computer application such as SAP™ ByDesign™.

Although the invention has been described above with reference to specific embodiments, the invention is not limited to the above embodiments and the specific configurations shown in the drawings. For example, some components shown may be combined with each other as one embodiment, or a component may be divided into several subcomponents, or any other known or available component may be added. The operation processes are also not limited to those shown in the examples. Those skilled in the art will appreciate that the invention may be implemented in other ways without departing from the sprit and substantive features of the invention. For example, features and embodiments described above may be combined with and without each other. The present embodiments are therefore to be considered in all respects as illustrative and not restrictive. The scope of the invention is indicated by the appended claims rather than by the foregoing description, and all changes that come within the meaning and range of equivalency of the claims are therefore intended to be embraced therein.

What is claimed is:

1. A method for generating at run-time, a user-defined task management device, comprising:
in response to an output from a graphical user interface at run-time, accessing, by a processor, a tasking template for completing a task, wherein the tasking template has a plurality of data fields and user-selectable controls;
identifying, by the processor, screens usable for completing a task associated with the accessed tasking template based on a data input into a data field of the plurality of data fields;
presenting the tasking template in a first portion of a display of a graphical user interface, and the identified screens in a second portion of the display of the graphical user interface;
populating, in response to an input to the graphical user interface, a data field in the plurality of data fields in the tasking template with one of the identified screens to generate a task screenflow from the task template; and
presenting in the graphical user interface the run-time, user-defined task screenflow for completing the task.

2. The method of claim 1, comprising:
storing the user-defined task screenflow in a data storage device.

3. The method of claim 1, comprising:
in response to a selection of a populated data field of the tasking template, accessing the identified screen in the populated data field;
opening a computer application associated with the screen; and
presenting a graphical user interface for entering data usable by the computer application to complete a task associated with populated data field.

4. The method of claim 1, wherein the screen may include a link to a data file, an executable file, or an electronic document.

5. The method of claim 1, comprising:
in response to a computer object trigger entered in a user for the task in a data field, presenting in a third portion of the screen of the graphical user interface, a list of recommended computer objects associated with the computer object trigger; and
in response to a selection of one of the computer objects from the list of recommended computer objects, populating a data field in the task template with the selected computer object.

6. The method of claim 1, comprising:
updating the task screenflow by selecting additional screens for the second portion of the graphical user interface.

7. The method of claim 1, comprising:
indicating in a data field of the graphical user interface, a user who is different from the task screenflow owner that is responsible for completing the task screenflow.

8. A computer system for generating at run-time, a user-defined task management device, comprising:
a display device for presenting a task management device;
a data storage device for storing data;
a processor communicatively coupled to the display device and the data storage device, wherein the processor is configured to:
in response to an output from a graphical user interface at run-time, access a tasking template for completing a task, wherein the tasking template has a plurality of data fields and user-selectable controls;
identify screens usable for completing a task associated with the accessed tasking template based on a data input into a data field of the plurality of data fields;
present the tasking template in a first portion of a display of a graphical user interface, and the identified screens in a second portion of the display of the graphical user interface;
populate, in response to an input to the graphical user interface, a data field in the plurality of data fields in the tasking template with one of the identified screens to generate a task screenflow from the task template; and
present in the graphical user interface the run-time, user-defined task screenflow for completing the task.

9. The computer system of claim 8, the processor is further configured to:
in response to a selection of a populated data field of the tasking template, access the identified screen in the populated data field;
open a computer application associated with the screen; and
present a graphical user interface for entering data usable by the computer application to complete a task associated with populated data field.

10. The computer system of claim 8, the processor is further configured to:
storing the task template with the user-defined task screenflow in a data storage device.

11. The computer system of claim 8, wherein the screen may be a link to a data file, an executable file, or an electronic document.

12. The computer system of claim 8, comprising:
in response to a computer object trigger entered in a user for the task in a data field, present in a third portion of the screen of the graphical user interface, a list of recommended computer objects associated with the computer object trigger; and
in response to a selection of one of the computer objects from the list of recommended computer objects, populating a data field in the task template with the selected computer object.

13. The computer system of claim 8, comprising:
update the task screenflow by selecting additional screens for the second portion of the graphical user interface.

14. The computer system of claim 8, comprising:
indicate in a data field of the graphical user interface, a user who is different from the task screenflow owner that is responsible for completing the task screenflow.

15. A machine-readable storage medium embodied with computer program instructions for causing a processor to execute a process for testing computer application functions, the process comprising:
in response to an output from a graphical user interface at run-time, accessing, by a processor, a tasking template for completing a task, wherein the tasking template has a plurality of data fields and user-selectable controls;
identifying, by the processor, screens usable for completing a task associated with the accessed tasking template based on a data input into a data field of the plurality of data fields;
presenting the tasking template in a first portion of a display of a graphical user interface, and the identified screens in a second portion of the display of the graphical user interface;
populating, in response to an input to the graphical user interface, a data field in the plurality of data fields in the tasking template with one of the identified screens to generate a task screenflow from the task template; and
presenting in the graphical user interface the run-time, user-defined task screenflow for completing the task.

16. The machine-readable storage medium of claim 15, the process further comprising:
storing the task template with the user-defined task screenflow in a data storage device.

17. The machine-readable storage medium of claim 15, the process further comprising:
in response to a selection of a populated data field of the tasking template, accessing the identified screen in the populated data field;
opening a computer application associated with the screen; and
presenting a graphical user interface for entering data usable by the computer application to complete a task associated with populated data field.

18. The machine-readable storage medium of claim 15, comprising:
updating the task screenflow by selecting additional screens for the second portion of the graphical user interface.

19. The machine-readable storage medium of claim 15, comprising:
indicating in a data field of the graphical user interface, a user who is different from the task screenflow owner that is responsible for completing the task screenflow.

20. The machine-readable storage medium of claim 15, wherein the screen may be a link to a data file, an executable file, or an electronic document.
